(19) United States
(12) Patent Application Publication
(10) Pub. No.: US 2018/0058133 A1
(43) Pub. Date: Mar. 1, 2018

(54) METHOD AND APPARATUS FOR PROVIDING A MODULAR SAFE

(71) Applicant: Robert Cyril Kay, Tehachapi, CA (US)

(72) Inventor: Robert Cyril Kay, Tehachapi, CA (US)

(21) Appl. No.: 15/247,865

(22) Filed: Aug. 25, 2016

(51) Int. Cl. E05G 1/024; E05G 1/04; E05G 1/026

(52) U.S. Cl. CPC E05G 1/024; E05G 1/04; E05Y 2800/416; E05Y 2800/205; E05G 1/026

(57) ABSTRACT

Modular safe for safekeeping valuable and methods for manufacture thereof utilizing individual components. Aspects of the present invention include safe components which can be manipulated and assembled by a customer. Specifically, a modular safe is provided by integrating individual safe components. A variety of design elements and fabrication techniques are available to the common customer giving rise to a secure vault whose construction location is clandestine.

### TECHNICAL FIELD

This invention relates generally to lockable enclosures having one or more doors which are shiftable between an open position in which access to the interior of the enclosure is permitted and a closed position in which a door blocks access to the interior of the enclosure. In another aspect, the present invention relates to lockable safes for securely storing valuable items. Specifically, manageable elements are combined to effect a robust, immovable safe.

### BACKGROUND

Safes are used for a variety of purposes. For example, in a home a person may use a safe for protecting valuables, such as personal jewelry, keepsakes, heirlooms and collectables. In an office, a person may use a safe to protect important documents and other items, such as petty cash and employees' personal possessions. Safes are available in a wide variety of sizes and shapes.

A safe (also called a strong box or coffer) is a secure lockable box used for securing valuable objects against theft and/or damage from fire. A safe is usually a hollow cuboid or cylinder, with one face being removable or hinged to form a door. Bank teller safes typically are secured to the counter, have a slit opening for dropping valuables into the safe without opening it, and a time-delay combination lock to foil robbers. One significant distinction between types of safes is whether the safe is secured to a wall or structure or if it can be moved around.

A diversion safe, or hidden safe, is a safe that is made from an otherwise ordinary object such as a book, a candle, a can, or even a wall outlet plug. Valuables are placed in these hidden safes, which are themselves placed inconspicuously (for example, a book would be placed on a bookshelf). Diversion safes are unsuitable for many applications. They rely on a thief's ignorance of location and recognition thereof. Diversion safes also suffer from dearth of volume to store securable items and lack of mass. Upon identification, a would-be thief can simply pickup and walk out with it.

Wall and floor safes are designed to provide hidden protection for documents and miscellaneous valuables. Adjustable depth allows the maximization of usable space when installed in different wall and floor thicknesses. Some wall safes feature pry resistant recessed doors with concealed hinges for anti-theft protection. A painting can be hung over a wall safe to hide it from public view.

A strongroom (e.g., bank vault) is a secure space where money, valuables, records, and documents can be stored. It is intended to protect their contents from theft, unauthorized use, fire, natural disasters, and other threats, much like a safe. Unlike safes, strongrooms are an integral part of the building within which they are built, using armored walls and a tightly fashioned door closed with a complex lock.

Historically, strongrooms were built in the basement of a bank where the ceilings were vaulted, hence the name. Modern bank vaults typically contain many safe deposit boxes, as well as places for teller cash drawers, and other valuable assets of the bank or its customers. They are also common in other buildings where valuables are kept such as post offices, grand hotels, rare book libraries and certain government ministries.

Vault technology developed in a type of arms race with bank robbers. As burglars came up with new ways to break into vaults, vault makers found innovative ways to foil them. Modern vaults may be armed with a wide array of alarms and anti-theft devices. Some nineteenth- and early-twentieth-century vaults were built so well that today they are almost impossible to destroy. These older vaults were typically made with steel-reinforced concrete. The walls were usually at least 1 ft. (0.3 m) thick, and the door itself was typically 3.5 ft. (1.1 m) thick. Total weight ran into the hundreds of tons. Today vaults are made with thinner, lighter materials that, while still secure, are easier to dismantle than their earlier counterparts.

Generally speaking, the more secure and attack resistant a safe is, the larger and heavier the safe is. This makes it impractical to provide convenient secure storage at home or for each individual employee in an office. Smaller and lightweight lock boxes generally available do not provide sufficient attack resistance to store valuable personal effects. For this reason, people often store valuables in a bank safe deposit box. However, in such cases access is subject to the bank hours and a person does not have immediate access to the items stored therein.

Professional installation is required for even modest security requirements, such as, a wall safe. Consequently, each of the above enumerated safes suffers from an important security risk: a thief's potential a priori knowledge regarding the details of an installation. Knowledge of the installation comprises important information, such as, make/model of the safe and location thereof.

The present invention seeks to overcome certain of these limitations and other drawbacks of the prior art, and to provide new features not heretofore available. What is needed is a burglar resistant safe comprised by customer-manageable components which allows the customer to secretly designate its construction location and prevent the need to store valuables in a bank safe deposit box. A more comprehensive discussion of the features and advantages of the present invention is deferred to the following detailed description, which proceeds with reference to the accompanying drawings.

The present disclosure contemplates a novel modular safe comprising components which can be assembled to give rise to a variety of safes up to including vaults, as well as practical methods for the application thereof and remedying these and/or other associated problems.

This overview is intended to provide an overview of subject matter of the present patent application. It is not intended to provide an exclusive or exhaustive explanation of the invention. Further limitations and disadvantages of conventional and traditional approaches will become apparent to one of skill in the art, through comparison of such systems with some aspects of the present invention as set forth in the remainder of the present application with reference to the drawings.

### SUMMARY

The present invention relates generally to safes, and more particularly to systems and methods for providing a quasi-portable safe. Specifically, manageable elements are combined to effect a robust, immovable safe. Aspects of the present invention include safe components which can ordered by a customer pursuant to his/her needs. Upon arrival, these components can be manipulated and assembled in a desired fashion and location known only to the customer. A variety of design elements and fabrication techniques are available to the common customer giving rise to a secure vault whose construction location is known only to the customer.

### BRIEF DESCRIPTION OF THE DRAWINGS

For a fuller understanding of the nature and advantages of the present invention, reference is made to the following detailed description of preferred embodiments and in connection with the accompanying drawings, in which:

FIG. 1 is an exemplary modular safe, in accordance with some embodiments of the disclosure provided herein;

FIG. 2 depicts an exploded view of an exemplary modular safe, in accordance with some embodiments of the disclosure provided herein;

FIG. 3 illustrates an exemplary assembly interface joining two walls of a modular safe, in accordance with some embodiments of the disclosure provided herein;

FIG. 4 is a diagram exemplifying the assembly interface in practice of a modular safe, in accordance with some embodiments of the disclosure provided herein;

FIG. 5 illustrates an alternate exemplary assembly interface joining two walls of a modular safe, in accordance with some embodiments of the disclosure provided herein;

FIG. 6 illustrates an alternate exemplary assembly interface joining two walls of a modular safe, in accordance with some embodiments of the disclosure provided herein;

FIG. 7 is an exemplary modular safe, in accordance with some alternate embodiments of the disclosure provided herein;

FIG. 8 depicts an exemplary modular safe with integrated theft prevention wings, in accordance with some embodiments of the disclosure provided herein; and,

FIG. 9 illustrates an exemplary stacked modular safe, in accordance with some embodiments of the disclosure provided herein.

### DETAILED DESCRIPTION

The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Other objects, advantages and novel features of the disclosure are set forth in the proceeding in view of the drawings where applicable.

This invention relates generally to lockable safes for securely storing valuable items. The inventor of the present invention has recognized the shortcomings of the related art wherein, traditional safes and installation thereof present security risks to the safe customer. The state of the current art allows for presence of information pertaining to the safe's make and model. The state of the current art permits knowledge regarding the safe's installation location.

The inventor of the present invention identifies this information as an unnecessary security risk. In that, it is known that safe salesmen and installers do not safeguard this information properly. Indeed, some of the unscrupulous members have purposely compromised the information for the purposes of theft. Additionally, even with the best intentions, digital data theft has become a global pandemic, if moved.

The present invention seeks to overcome these shortcomings by disclosing a safe which can be ordered, assembled and installed by the common customer thereby obviating many of the security concerns of the current state of the art. The safe is modular in design. That is, it is manufactured and shipped in fundamentally robust components. A customer chooses from a variety of models suiting his/her needs.

Upon arrival, the components are assembled in a choice of the customer's choosing without anyone else's knowledge. Installation can be made in any of the traditional places, such as, wall, floor, closet, etc. Or, more clandestine installation locations can be selected, e.g., false rooms, false walls, subfloors, etc. In some embodiments of the present invention, a modular safe can be fabricated in such a manner that makes its removal impermissible. For example, a modular safe can be constructed so large that is will not fit through any doorway or window. In another example, a modular safe could be assembled with enough mass that any surrounding floors or floorboards would collapse under the weight of the safe. In some embodiments, floor supports are constructed such that when in place, the floor supports the weight of the safe. That is, the floor support are location specific. Consequently, during an attempted theft (when moved) the floors or floorboards would collapse under the weight of the safe.

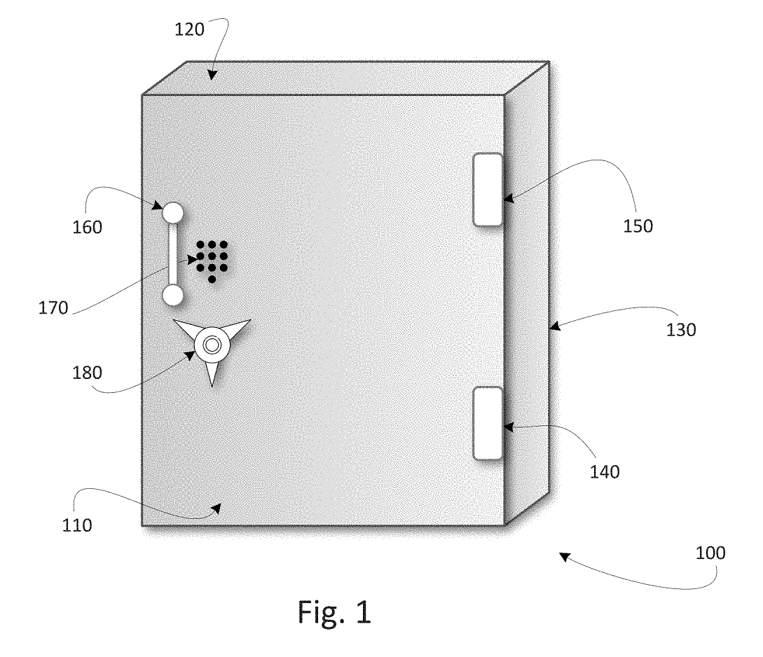

FIG. 1 is an exemplary modular safe 100, in accordance with some embodiments of the disclosure provided herein. Modular safe 100 is depicted in its fully assembled state and comprises main panel 110, top panel 120 and side panel 130, at least in part. In one or more embodiments, main panel 110 comprises handle 160, locking mechanism 170, locking bolt actuator (throw) 180, and hinges 140, 150.

In the present embodiment, locking mechanism 170 is a keypad. Well known in the art, a keypad is electronic locking mechanism whereby an entered code gives access to the safe. The keypad also gives you the option of entering an alternate alert code that simultaneously unlocks the vault and alerts authorities or security personnel that a break-in is taking place.

In other embodiments, the locking mechanism 170 is a dial requiring a numeric combination to gain entry into modular safe 100. In yet other embodiments, locking mechanism 170 is a key. In some embodiments, locking mechanism 170 is a biometric lock. Biometric locks are keyed to your fingerprints—just touch and open. The interface allows you to add or delete authorized customers, and a keypad can also be set to accept a keyed-in security code in addition to, or instead of, fingerprint access.

In some embodiments, locking mechanism 170 further comprises a timelock. A timelock mechanism is the equivalent of a self-lockout; once set the timelock disables the locking/unlocking mechanism entirely, keeping the vault door closed until the set time limit has expired. Any combination of the aforementioned locking mechanisms is not beyond the scope of the present invention.

Locking bolts slide from the vault door through the doorjamb, securing the door in place. Bolts may protrude from the outside edge of the door, or from the top and bottom of the door as well. In some embodiments, locking bolt actuator (throw) 180 rotates about an axis orthogonal to the plane of main panel 110. Well known in the art, locking bolt actuator 180 dynamically displaces the modular safe's 100 locking bolt from a locked position to an unlocked one, and vice-versa. In other embodiments, locking bolt actuator 180 can move in any direction and any suitable means to actuate the locking bolt, electric or otherwise, is not beyond the inventor's possession of the present invention.

In the present embodiment, hinges 140, 150 are outswing and made of steel. In other embodiments, hinges 140, 150 are inswing and made of any suitable material or alloy. Because you don't need clear space on the outside of the vault, inswing doors make it easier to conceal the vault door and are also suitable if you intend to use the vault as a fire refuge.

In some embodiments, the individual component panels are hollow and open at one end. The individual component panels are filled with precast concrete pavers on site. In some embodiments, fire insulation may be added to the hollowed individual component panels either at the factory or onsite. So, a consumer has the option of either adding weight or fire insulation or some combination thereof.

Main panel 110, top panel 120 and side panel 130 are made of a minimum of half inch solid steel, preferably one to one and half inch thickness. In some embodiments, main panel 110, top panel 120 and side panel 130 are made of M-rated ballistic plate armor, which offers superior penetration resistance with less weight than steel.

Re-lockers are hardened steel pins that shoot into place when the vault door or lock is compromised. In some embodiments, modular safe 100 comprises one or more of the following re-lockers and re-locker triggers. Cable-triggered re-lockers are secured by cables anchored to the vault door's lock. If the lock becomes dislodged, the cable releases and the locking pins snap into place.

Thermal re-lockers are cable re-lockers that are fixed to an anchor point of low melting point metal. During a torch or thermic lance attack, the metal anchor point melts and releases the re-lockers. Glass plate re-lockers are triggered by a pane of safety glass set between the lock and the door. Any attempt to reach the lock fractures the glass, releasing the re-lockers.

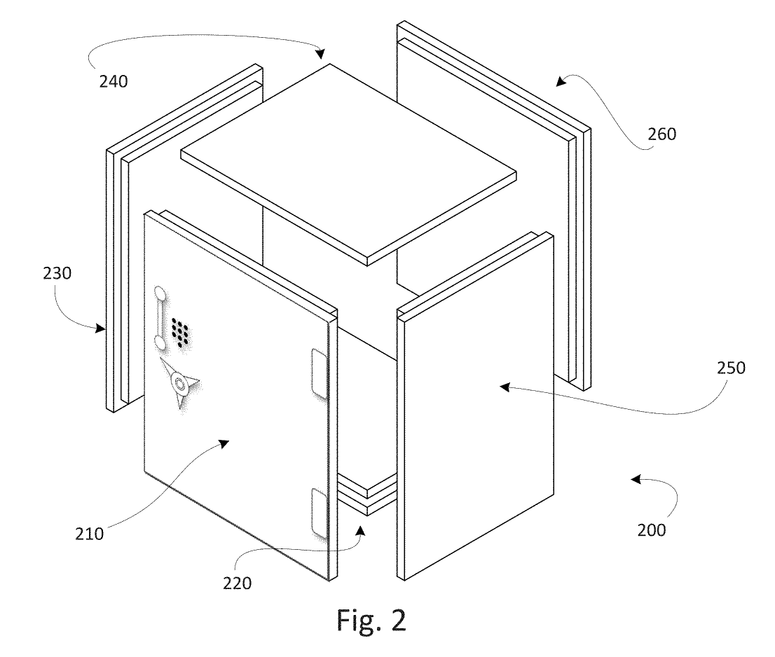

FIG. 2 depicts an exploded view of an exemplary modular safe 200, in accordance with some embodiments of the disclosure provided herein. Modular safe 200 comprises main panel 210, floor panel 220, ceiling panel 240 and side panels 230, 250, 260. FIG. 2 typifies the sub-assemblies and state in which main panel 210, floor panel 220, ceiling panel 240 and side panels 230, 250, 260 would be shipped or delivered.

Upon receipt, a customer assembles modular safe 200 pursuant to the type of joint, which will be discussed in greater detail later in the disclosure. Side panels 230, 250, 260 are affixed to floor panel 220. Followed by the ceiling panel 240 being affixed to the side panels 230, 250, 260. Main panel 210 is then fitted to floor panel 220, ceiling panel 240 and side panels 230, 250.

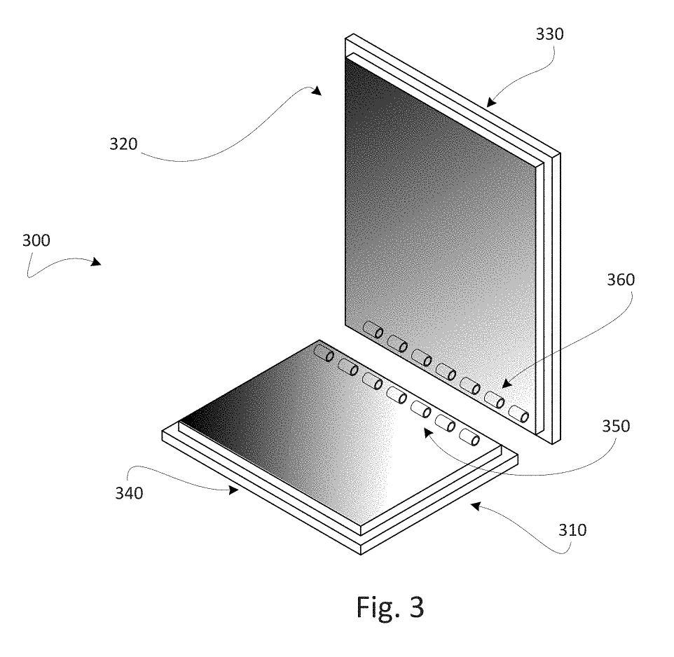

FIG. 3 illustrates an exemplary assembly interface 300 joining two walls of a modular safe 200, in accordance with some embodiments of the disclosure provided herein. In the present embodiment, joining interfaces 350, 360 are akin to two halves of a hinge joint. That is, joining interfaces are substantially cylindrical with hollowed interiors and alternate in a duty cycle fashion along their longitudinal axes. The properly offset from one another to allow for mating of joining interfaces which are adhered to floor panel 310 and side panel 320. As can be seen, floor panel and side panel 320 both have grooved reliefs 330, 340 which further allow for a proper seal and interface to be achieved.

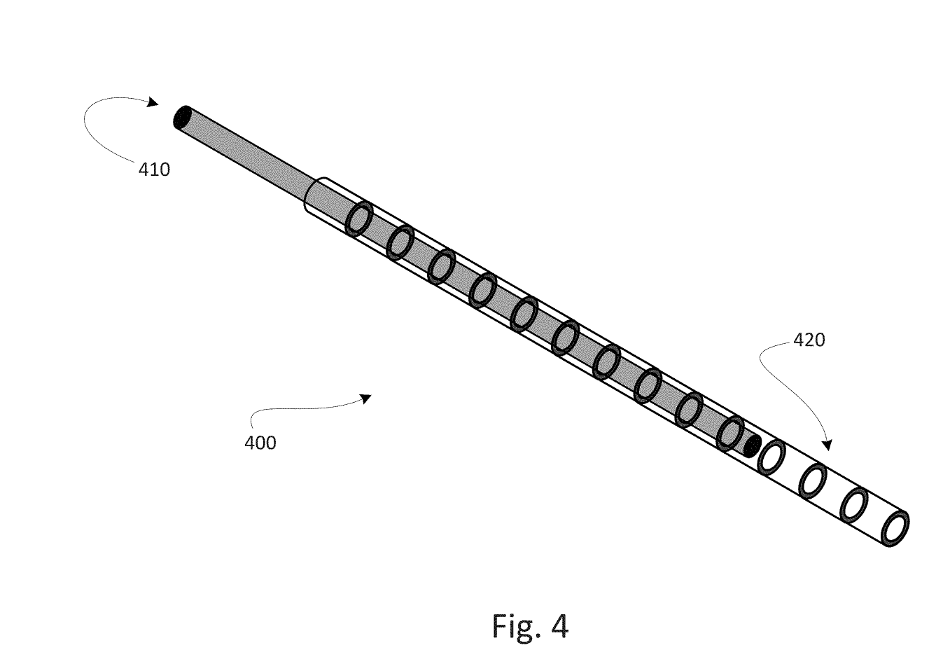

FIG. 4 is a diagram exemplifying an interface 400 in practice of assembling a modular safe, in accordance with some embodiments of the disclosure provided herein. One skilled in the art can appreciate that hinge 420 represents the mated joining interface 350, 360 depicted in FIG. 3. Mating pin 410 is feed through hinge 420 to secure joining interfaces 350, 360 together. In the present embodiment, mating pin 410 and hinge 420 are made of steel. However, in other embodiments, mating pin 410 and hinge 420 are made of any other suitable material, such as, carbon fiber, Kevlar, titanium or any other metallic or non-metallic material.

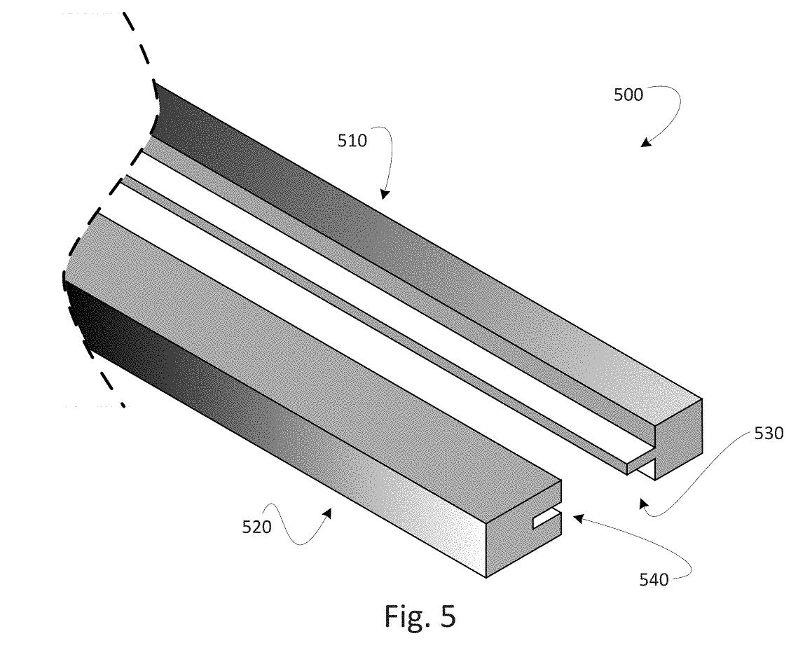

FIG. 5 illustrates an alternate exemplary assembly interface 500 joining two walls of a modular safe 200, in accordance with some embodiments of the disclosure provided herein. Panels 510, 520 fit together according to another male/female mating interface. In the present embodiment, panels 510, 520 comprise tongue 530 and groove 540 joints, respectively. Tongue 530 is substantially similar in size to groove 540. The two are fitted together and held in place by one or more of the following methods: brazing, welding, structural adhesive, dowel pin, epoxy or any other suitable method known in the art.

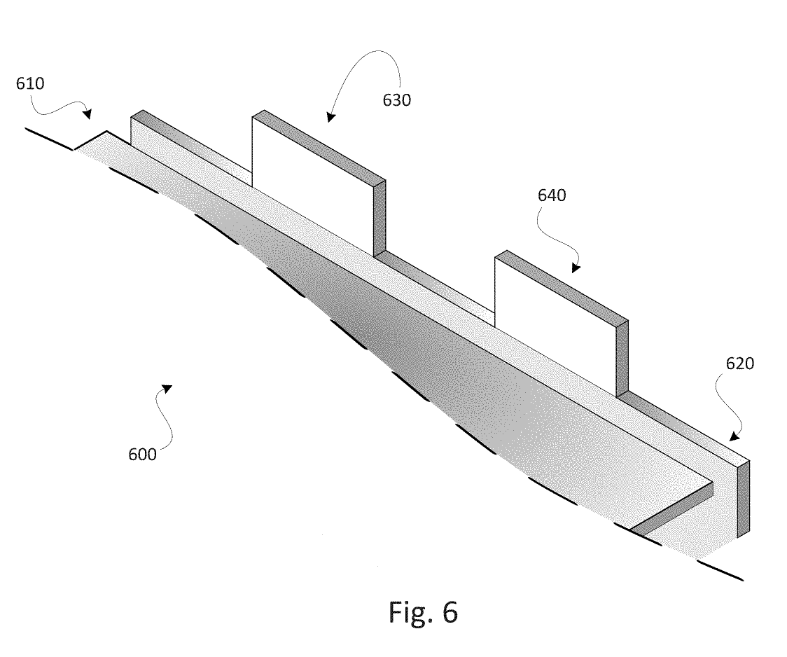

FIG. 6 illustrates an alternate exemplary assembly interface 600 joining two walls 610, 620 of a modular safe 200, in accordance with some embodiments of the disclosure provided herein. In the present embodiment, tabs 630, 640 are comprised by and manufactured with wall 620. In other embodiments, tabs 630, 640 are welded onto wall 620 post casting and/or machining. Tabs 630, 640 are peened or folded over onto the face of wall 610. The folded tabs 630, 640 are then secured to wall 610 using one of the aforementioned methods.

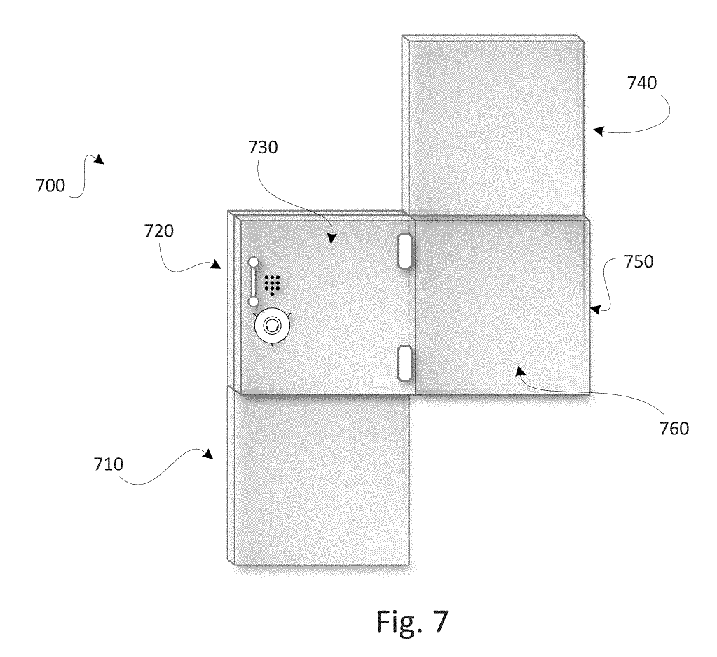

FIG. 7 is an exemplary modular safe 700, in accordance with some alternate embodiments of the disclosure provided herein. In contrast with previous embodiments, modular safe 700 is shipped and delivered in a substantially assembled state. However, modular safe 700 is flattened like a corrugated cardboard box. Turning to FIG. 7, main panel 730 is affixed to side panels 720, 760 in a substantially dynamic fastening joint, such as, hinge 420 of FIG. 4. Similarly, rear panel 750 is affixed to side panels 720, 760. Upon receipt, side panels 720, 760 main panel 730 and rear panel 750 articulate outward from one another thereby creating a center void. Top panel 740 and bottom panel 710 are then folded and secured to the side panels 720, 760, main panel 730 and rear panel 750. In the present embodiment, top and bottom panels 740, 710 are manufactured dynamically secured to the modular safe 700 assembly. In other embodiments, they are shipped and affixed separately.

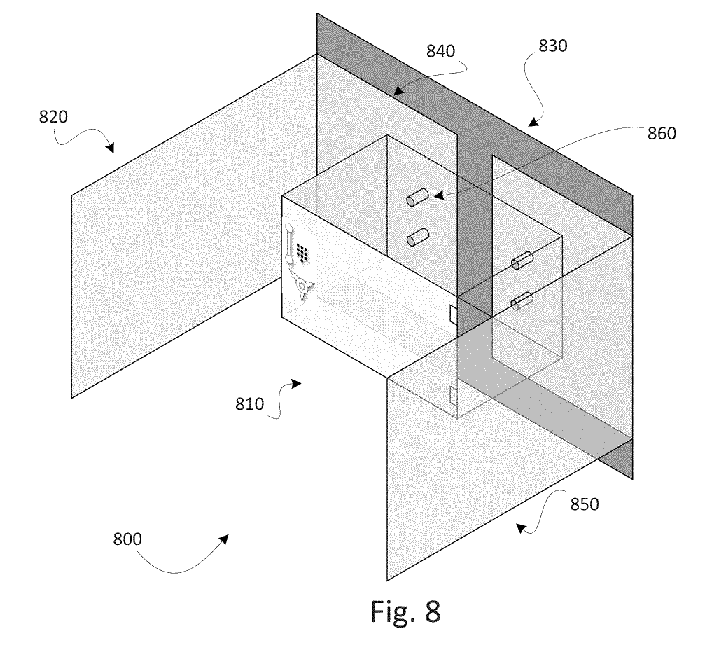

FIG. 8 depicts an exemplary modular safe 800 with integrated theft prevention wings 820, 840, in accordance with some embodiments of the disclosure provided herein. Modular safe 800 comprises safe 810, integrated theft prevention wings 820, 840 and integrators 860. In one or more embodiments, safe 810 is of a self-assembly type as described previously in the disclosure. In other embodiments, safe 810 is a prefabricated safe with accommodation for the integrators 860. In the present embodiment, the accommodations are holes and the integrators 860 are bolts and/or threaded rods which are fastened securely to the back plate 840 of theft prevention wing 820.

In practice, all the components of modular safe 800 are shipped separately and assembled by a customer. The motivation of the present embodiment of the invention is such that the assembly and construction of modular safe 800 in a confined room or area precludes removal thereof. Theft prevention wings 820, 840 are made of steel or other suitable material and can be made to order to fit a room or closet space. In some embodiments, the exact location of the integrators 860 have not been set thereby providing some flexibility to the customer. For example, a slots are provided in the back plate 840 to allow for integrators 860 which are bolts. In other embodiments wherein the integrators 860 are threaded rods, a customer may weld integrators 860 at any desired location so as to fit a room.

Safe 810 get mounted onto integrators 860 and securely fastened from the inside of the safe 810 by means of nuts, welding or other suitable means which are known in the art. Those in the art can appreciate that in order to remove theft prevention wings 820, 850, a thief would necessarily have to access the interior of the safe itself. Theft prevention wings 820, 850 get securely fastened to rear wall 830 wings snug fitted to any suitable, such as a home wall found in the back of a closet. In a preferred embodiment, safe 810 is 18 inches substantially cubic weighing 100 lbs, while theft prevention wings 820, 850 measure 2 sqr. ft. and weight 50 lbs each.

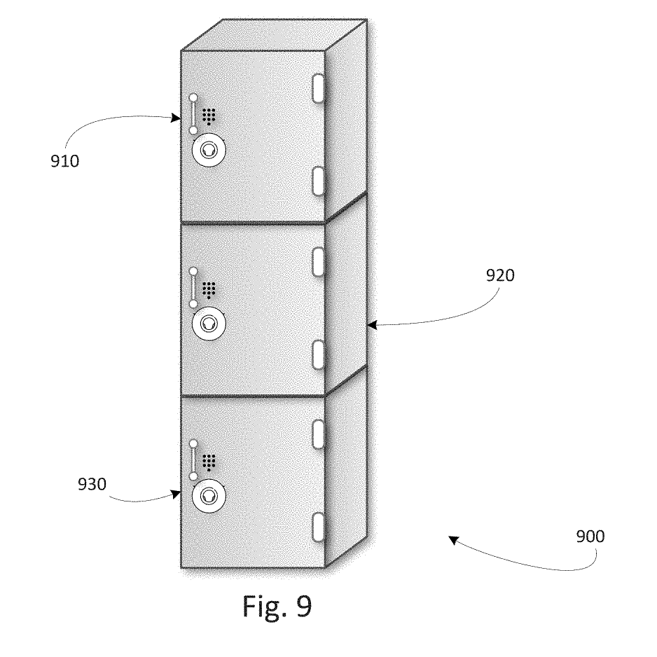

FIG. 9 illustrates an exemplary stacked modular safe 900, in accordance with some embodiments of the disclosure provided herein. In one or more embodiments, individual safes 910, 920, 930 are stacked and integrated together. Individual safes 910, 920, 930 can be modular as previously described or shipped prefabricated. The inventor points out that the novelty behind such an arranged is to produce a stack modular safe 900 which is cumbersome and difficult to remove. Integration techniques can be those as described in association with the embodiment found in FIG. 8, e.g., internally connected integrators other suitable means. In a preferred embodiment, stacked modular safe comprise 7 individual safes, each of which weighing 100 lbs.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein.

Those skilled in the art will recognize, or be able to ascertain using no more than routine experimentation, many equivalents to the specific embodiments described herein. It is, therefore, to be understood that the foregoing embodiments are presented byway of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The present invention should therefore not be considered limited to the particular embodiments described above. Various modifications, equivalent processes, as well as numerous structures to which the present invention may be applicable, will be readily apparent to those skilled in the art to which the present invention is directed upon review of the present disclosure.

What is claimed is:

1. A consumer manufactured modular safe comprising:
a plurality of sides, wherein each of the sides are shipped to said consumer separately;
a floor shipped to said consumer separately from each of said sides; wherein, said floor is integrated with said plurality of sides by said consumer;
a ceiling shipped to said consumer separately from each of the sides or floor; wherein, said ceiling is integrated with said plurality of sides by said consumer;
a front door having a locking mechanism; wherein, the front door is shipped to said consumer separately from each of the sides, ceiling or floor;
wherein, said front door is integrated with said floor, said ceiling and at least two of said plurality of sides by the consumer.

2. The consumer manufactured modular safe claim 1, wherein said modular safe is substantially comprised by steel.

3. The consumer manufactured modular safe claim 1, wherein said plurality of sides, floor and ceiling are consumer integrated by welding.

4. The consumer manufactured modular safe claim 3, wherein said built in integrators are substantially hinge shaped which mate using a dowling pin.

5. The consumer manufactured modular safe claim 3, wherein said built in integrators are substantially tongue and groove shapes which mate together during integration.

6. The consumer manufactured modular safe claim 3, wherein said built in integrators are substantially tab shaped which get hammered over and welded in place during consumer integration.

7. The consumer manufactured modular safe claim 1, wherein said locking mechanism comprises a dial.

8. The consumer manufactured modular safe claim 1, wherein said locking mechanism comprises a keypad.

9. The consumer manufactured modular safe claim 1 further comprising one or more wings which integrate to the rear of said modular safe.

10. The consumer manufactured modular safe claim 9, wherein said one or more wings are made substantially of steel.

11. The consumer manufactured modular safe claim 9, wherein said one or more wings are integrated via holes in the back of said modular safe.

12. The consumer manufactured modular safe claim 11, wherein said one or more wings further comprise studs which feed through said holes for the purposes of consumer integration.

13. The consumer manufactured modular safe claim 12, wherein said studs are secured through said holes with nuts in the interior or said safe.

14. The consumer manufactured modular safe claim 12, wherein said studs are secured through said holes by consumer welding in the interior or said safe.

15. The consumer manufactured modular safe claim 1, wherein said plurality of sides are substantially hollow.

16. The consumer manufactured modular safe claim 15, wherein said plurality of sides are filled with fire retardation.

17. The consumer manufactured modular safe claim 15, wherein said plurality of sides are filled with concrete.

18. A foldable box safe comprising:
a first side;
a second side;
a third side which flexibly couples to said first and second side;
a front face which flexibly couples to said first and second side, wherein said front face comprises a locking mechanism;
a top which flexibly couples to said third face; and,
a bottom which flexibly couple to said side,
wherein, said top and bottom interfaces with said first, second, third sides and front face thereby creating a substantially cubic interior space.

19. The foldable box safe of claim 18, wherein said flexible couples are hinges.

20. The foldable box safe of claim 18, wherein said interior cubic space is welded in place.

21. A consumer manufactured modular safe comprising a stacked plurality of safes, wherein each of said plurality is integrated to at least it's closest neighbor.
